(19) United States
(12) Patent Application Publication
(10) Pub. No.: US 2013/0145357 A1
(43) Pub. Date: Jun. 6, 2013

(54) INTEGRATING APPLICATIONS

(71) Applicant: Jacek Korycki, San Jose, CA (US)

(72) Inventor: Jacek Korycki, San Jose, CA (US)

(21) Appl. No.: 13/311,232

(22) Filed: Dec. 5, 2011

(51) Int. Cl. G06F 9/44

(52) U.S. Cl. 717/172

(57) ABSTRACT

Method, computer program product and device for integrating a client application, associated with a service provider, with at least one web application instance implemented on a device platform of a device. A respective at least one user interface module of the client application is embedded into the at least one web application instance, wherein the at least one user interface module is implemented using web-based technology. Native parts of the client application are implemented in a centralized manner on the device, wherein the native parts of the client application are installed on the device and implemented using technology that is native to the device platform. A control module of the client application is implemented in a centralized manner on the device, wherein the control module is implemented using web-based technology.

### TECHNICAL FIELD

The present invention relates to integrating applications. In particular the present invention relates to integrating a client application associated with a service provider with one or more web application instances on a device.

### BACKGROUND

A service provider may provide a client application for use on a device. The client application may be installed on the device for subsequent use on a device platform of the device. In some situations the service provider may provide a client application which is a hybrid application in the sense that it has some web-based components which utilize a web-based technology (e.g. in accordance with the HTML 5 standard) and some native components which utilize a technology which is native to the device platform (e.g. C++). The native parts of the client application allow the client application to function in accordance with the technology implemented by the service provider. On the other hand, the web-based components of the client application allow the client application to be integrated with other applications implementing web-based technology in a simple manner. In particular, a user interface (UI) module of the client application may be implemented using web-based technology so that the UI module of the client application can be embedded in a web-based application such as an instance of a web application (executing in the browser) which is provided by an entity (referred to herein as a “partner”) other than the service provider. An instance of a web browser may refer to any separate interface of a web browser with which a user can interact, such as a window, tab or frame of a web browser or instances of different web browsers from different vendors such as Microsoft Internet Explorer and Google Chrome. Each web application instance can retrieve suitable UI widgets of the client application from the service provider and can implement the UI widgets in the web application instance. For example, the web application instance may load JavaScript and Cascading Style Sheet (CSS) files from a server associated with the service provider, wherein the JavaScript code can be invoked by the web application instance to instantiate specific UI elements of the client application within the web application instance.

It can be beneficial to maximize the proportion of web technology in the service provider client application, to thereby keep the native parts of the client application to a minimum. Web-based technologies have superior upgrade capabilities compared to the native technologies. For example, JavaScript, CSS and HTML files can be dynamically downloaded over the Internet, thereby making it simple to change (e.g. upgrade) the web-based parts of the client application. In contrast, changing the native parts of the client application would require an installation of the native parts (using the native technologies, e.g. C++) on the device, which may be more difficult than downloading files over the Internet. A control and state module of the client application and the native parts of the client application may be embedded into each web application instance on the device. This allows the control and state module of the client application to use a web-based technology (rather than a native technology). However, by embedding the control and state module of the client application into each web application instance on the device, there is no ability to co-ordinate between the integration of the client application with multiple web application instances from multiple partners. Each partner integration forms a separate silo on the user device preventing global control of the client application across multiple web application instances on the device from multiple partners. Furthermore, this method is only suitable if there is no constraint against multiple instantiations on the device of the native parts of the service provider application. There may be reasons for constraining the native parts of the client application to be instantiated only once on the device, these reasons including resource constraints or legacy considerations. The constraint that the native parts of the client application are instantiated only once on the device is found in practice for example in the realm of client applications handling Internet communication services.

### SUMMARY

According to a first aspect of the invention there is provided a method of integrating a client application, associated with a service provider, with at least one web application instance implemented on a device platform of a device, the method comprising: embedding a respective at least one user interface module of the client application into the at least one web application instance, said at least one user interface module being implemented using web-based technology; implementing native parts of the client application in a centralized manner on the device, said native parts of the client application being installed on the device and being implemented using technology that is native to the device platform; and implementing a control module of the client application in a centralized manner on the device, said control module being implemented using web-based technology.

Advantageously the control module (which may be a control and state module of the client application) is implemented centrally on the device thereby allowing for centralized device-wide control of the client application at the device, such that the client application behaviour across the device can be co-ordinated. Furthermore, the control module is implemented using web-based technology on the device, thereby allowing the control module to be changed (e.g. upgraded) using the web-based technology.

Embodiments of the invention provide new and improved solutions for a problem of how to implement client-side web integration (also known as a “mash-up”) between a hybrid web and native client application provided by a service provider and web applications provided by “partners” (i.e. entities other than the service provider). Elements of the hybrid client application, including the UI module, can be inserted (that is, embedded) into one or more web application instances of the partner. Where there is more than one web application instance on the device the elements of the hybrid client application can be embedded into the web application instances of a partner simultaneously with other partner applications. Embodiments are particularly useful in an environment where the native parts of the service provider client application can be instantiated only once on the device at a time. As described above, there can be many reasons for such a constraint, including resource constraints or legacy considerations, and this constraint can be found in practice, for example in the realm of Internet communication services.

In preferred embodiments the service provider client application is split into three components:
1. User interface modules (referred to herein as “UI widgets”), implemented in a web technology, such as a pure web technology, e.g. utilizing HTML 5. Multiple such UI widgets may be embedded into multiple instances of various partner web applications, running concurrently on the device.
2. Native parts of the application, instantiated exactly once, and running within a separate native program, referred to herein as a “central application daemon”.
3. A centralized web-based control and state module, built with web technology, such as a pure web technology, e.g. utilizing HTML 5. This control and state module is instantiated exactly once, servicing the needs of many UI widgets. It mediates the access of UI widgets to the native parts of the application. It also runs all the time independently of any UI widget.

As described above, advantageously, two usually contradictory goals can be achieved in embodiments:
1. The proportion of the web technology in the service provider client application is maximized, thereby keeping the native parts of the client application small. This allows the superior upgrade capabilities inherent to web-based technologies to be implemented as described above. HTML 5 artefacts for the web-based parts of the client application can be downloaded to the device on demand from a web server of the service provider, in the form of JavaScript, CSS and HTML files. This allows the service provider to easily change (e.g. upgrade) the web-based parts of the client application (which includes the control module of the client application), in a way similar to the way in which revisions are made to web content.
2. A centralized, device-wide control and state module is provided, for the sake of ultimate coordination of the client application behaviour across the device.

There may be only one instance of the native parts of the client application implemented on the device at a time. Similarly, there may be only one instance of the control module of the client application implemented on the device at a time.

In preferred embodiments, the native parts of the client application and the control module of the client application are implemented using a centralized program on the device.

The native parts of the client application may include at least one of: (i) native libraries of the service provider, (ii) a Remote Procedure Call hub for facilitating signalling between components on the device which use web-based technology, and (iii) an instance of a JavaScript engine.

The control module may be downloaded to the device from the service provider via the Internet.

The method may further comprise upgrading the control module via web-based communication.

The control module may facilitate access between the at least one user interface module and the native parts of the client application.

A respective browser plugin may be implemented for each web application instance, said browser plugin having Remote Procedure Call (RPC) functionality for communicating with at least one of the control module and the native parts of the client application. The Remote Procedure Call functionality may facilitate Transmission Control Protocol (TCP) connections for relaying control messages between the at least one web application instance and said at least one of the control module and the native parts of the client application. The control messages may be relayed using publish-subscribe communication.

There may be a plurality of web application instances implemented on the device, wherein each web application instance may be controlled by the control module of the client application.

The control module may be a control and state module of the client application.

The web based technology may conform to the HTML 5 standard.

According to a second aspect of the invention there is provided a computer program product for integrating a client application, associated with a service provider, with at least one web application instance implemented on a device platform of a device, the computer program product being embodied on a non-transient computer-readable medium and configured so as when executed on a processor of the device to perform the operations of: embedding a respective at least one user interface module of the client application into the at least one web application instance, said at least one user interface module being implemented using web-based technology; implementing native parts of the client application in a centralized manner on the device, said native parts of the client application being installed on the device and being implemented using technology that is native to the device platform; and implementing a control module of the client application in a centralized manner on the device, said control module being implemented using web-based technology.

According to a third aspect of the invention there is provided a device configured to integrate a client application, associated with a service provider, with at least one web application instance implemented on a device platform of the device, the device being configured to: embed a respective at least one user interface module of the client application into the at least one web application instance, said at least one user interface module being implemented using web-based technology; implement native parts of the client application in a centralized manner on the device, said native parts of the client application being installed on the device and being implemented using technology that is native to the device platform; and implement a control module of the client application in a centralized manner on the device, said control module being implemented using web-based technology. The native parts of the client application and the control module of the client application may be implemented using a centralized program on the device.

### BRIEF DESCRIPTION OF THE DRAWINGS

For a better understanding of the present invention and to show how the same may be put into effect, reference will now be made, by way of example, to the following drawings in which:

FIG. 1 shows a system according to a preferred embodiment;

FIG. 2 represents an integration of web application instances and a client application in a first prior art arrangement;

FIG. 3 represents an integration of web application instances and a client application in a second prior art arrangement;

FIG. 4 represents an integration of web application instances and a client application in accordance with a preferred embodiment;

FIG. 5 is a flow chart for a process of integrating a client application with at least one web application instance according to a preferred embodiment;

FIG. 6 is a first message sequence diagram of an example interaction between components of the client application and components of a web application instance; and

FIG. 7 is a second message sequence diagram of an example interaction between components of the client application and components of two web application instances.

### DETAILED DESCRIPTION

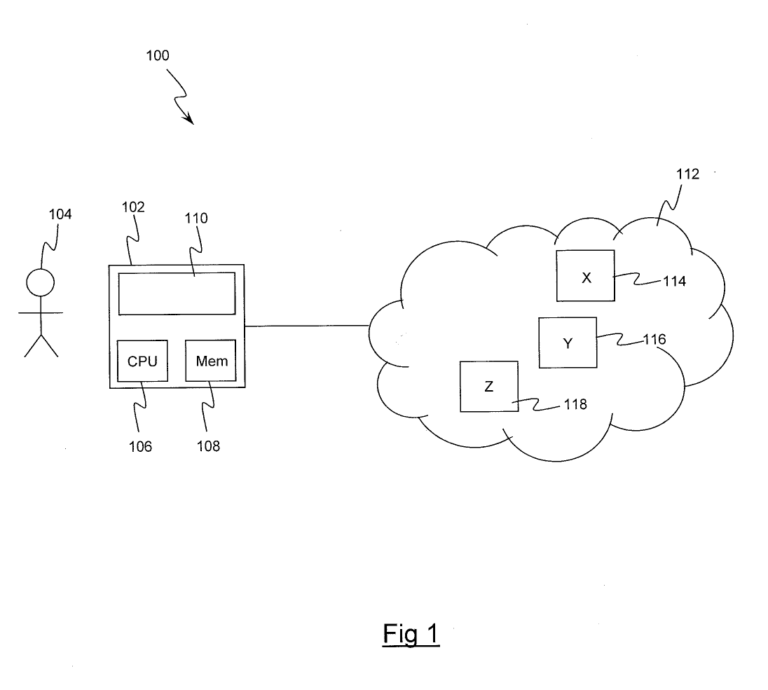

FIG. 1 shows a system 100 in which a device 102 operates. The device 102 is capable of communicating over a network 112 of the system 100. The device 102 is associated with a user 104 and comprises a processor (CPU) 106 for processing data on the device 102 and a memory 108 for storing data on the device 102. The device 102 may be a fixed or a mobile device. The device 102 may be, for example, a mobile phone, a personal digital assistant (“PDA”), a personal computer (“PC”) (including, for example, Windows™, Mac OS™ and Linux™ PCs), a laptop, a television, a gaming device or other embedded device able to connect to the network 112. The device 102 is arranged to receive information from and output information to the user 104. For example, the device 102 includes a display 110 for outputting visual data to the user 104. The display 110 may include a touch-sensitive screen allowing the user 104 to input data to the CPU 106 via the display 110. The device 102 may include further component providing a user interface with the user 104 which are not shown in FIG. 1. For example the device 102 may include a microphone for receiving audio signals; audio output means 210 for outputting audio signals; and/or a keyboard, keypad, joystick or mouse for receiving an input from the user 104. The device 102 implements a device platform on which applications can be executed. For example the device platform may be adapted to be suited to a mobile device or to be suited to a fixed device. The device platform describes the environment in which applications are implemented at the device 102 and may include: (i) an operating system implemented on the device 102, and/or (ii) a particular type of device, e.g. a mobile device having a small screen or a fixed device having a large screen.

The network 112 may, for example, be the Internet. As shown in FIG. 1, the system 100 includes three servers on the network 112: server X 114, server Y 116 and server Z 118. The system 100 is arranged so that the device 102 can communicate with the servers 114, 116 and 118 over the network 112, such that data can be transmitted between the device 102 and the servers 114, 116 and 118. As an example, the server 114 has a web address of “x.com”, the server 116 has a web address of “y.com” and the server 118 has a web address of “z.com”. In the preferred embodiments described herein the server 114 is a server operated by a service provider which can provide a client application for installation on the device 102, whereas the servers 116 and 118 are web servers allowing the device 102 to download web pages over the network 112 for display on the display 110 of the device 102.

The preferred embodiments described herein relate to integrating a client application of the service provider with web application instances associated with the web servers 116 and 118.

Two different approaches are in use in the prior art to integrate a hybrid service provider client application with web application instances on the device 102.

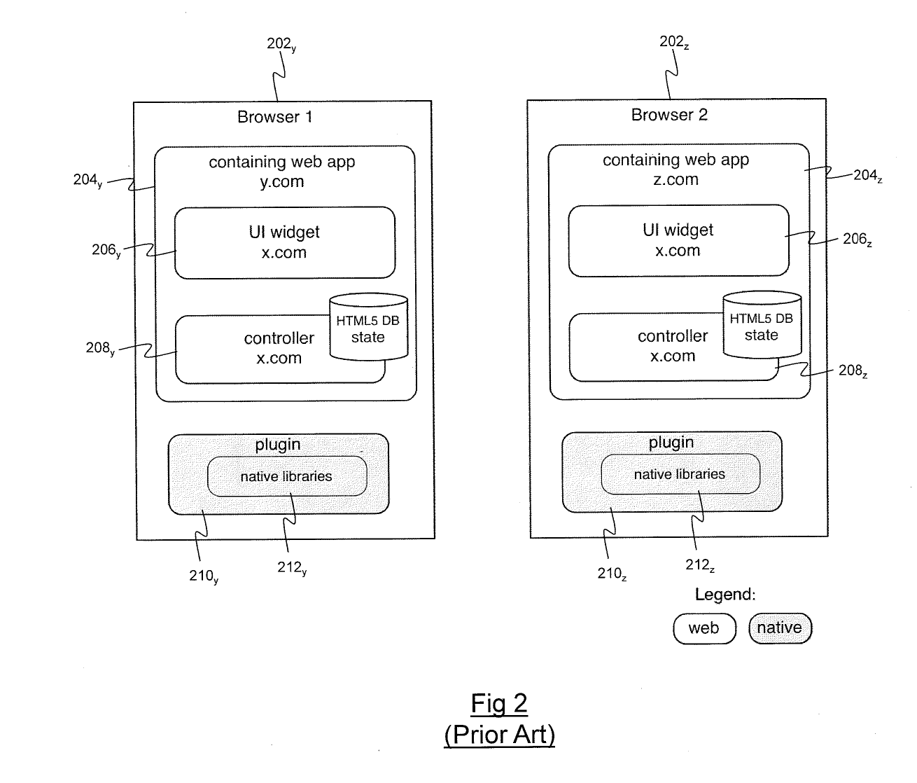

FIG. 2 represents an integration of two web application instances 204_{y} and 204_{z} with a client application in a first prior art arrangement. In this first prior art arrangement the native parts of the client application are hosted by a respective plugin 210 in the web application instances 202. The applications referred to herein are executed on the CPU 106 of the device 102 in accordance with known techniques for executing applications. If the applications are to store data then the data may be stored in the memory 108 of the device 102.

The web browser 202_{y} is associated with the server Y 116 operated by a partner Y. The web browser 202_{y} includes a web application instance 204_{y} which is implemented on the device 102. The web browser 202_{y} also includes a browser plugin 210_{y} which implements an instance of the native parts (including the native libraries 212_{y}) of the client application on the device 102. Similarly, the web browser 202, is associated with the server Z 116 operated by a partner Z. The web browser 202, includes a web application instance 204_{z} which is implemented on the device 102. The web browser 202, also includes a browser plugin 210, which implements an instance of the native parts (including the native libraries 212_{z}) of the client application on the device 102.

The web application instances 204_{y} and 204_{z} originated at web servers 116 and 118 at domains y.com and z.com and are downloaded to the device 102 via the network 112. Each of these web application instances 204_{y} and 204_{z} runs in a separate instance of a web browser (202_{y} and 202_{z}). By the instance of the web browser it is meant herein a window, tab, or frame, including concurrent use of various browser vendors (e.g. Browser1: Microsoft Internet Explorer, Browser2: Google Chrome). Each web application instance 204_{y} and 204_{z} constructs suitable UI widgets (206_{y} and 206_{z} respectively) of the service provider. The UI widgets 206 are UI modules of the client application of the service provider. The UI widgets 206 originated at the web server 114 of the service provider at domain x.com.

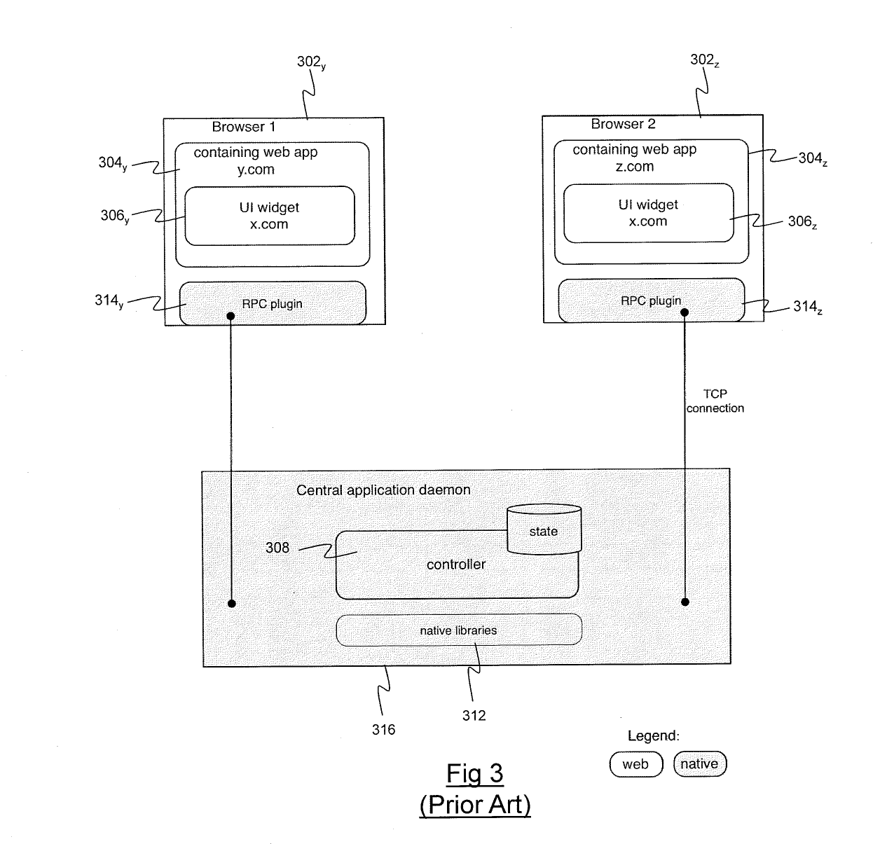

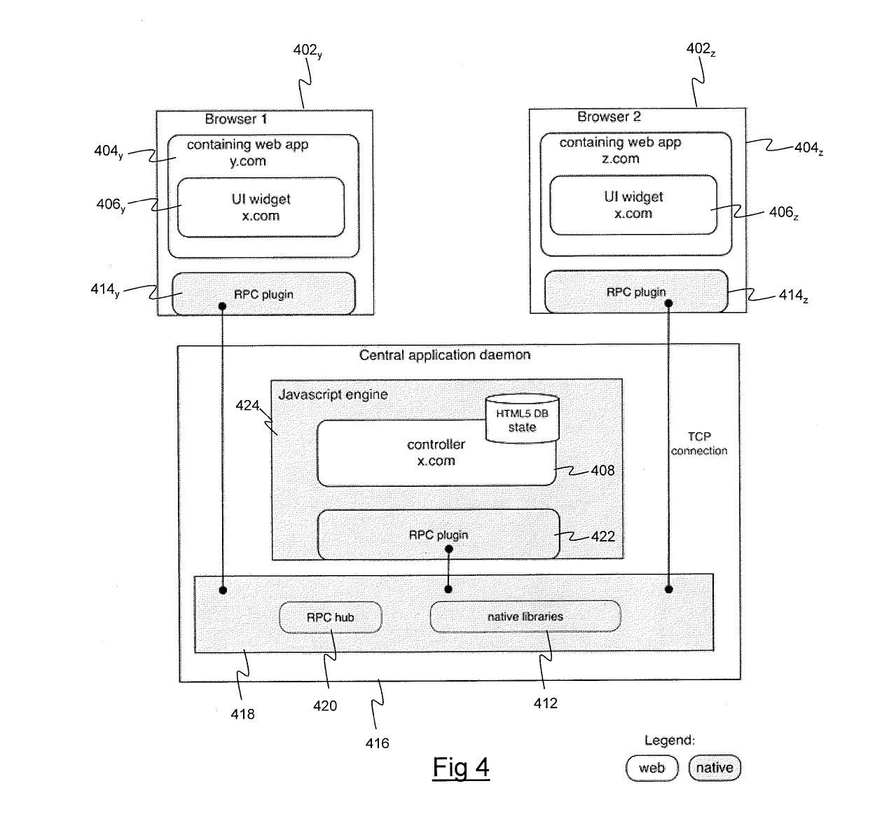

In FIG. 2 (and in FIGS. 3 and 4 described below) we indicate with white colour web components implemented at the device 102 which conform to the HTML 5 standard, e.g. those components implemented with HTML, JavaScript and CSS tools. With grey colour in FIG. 2 (and in FIGS. 3 and 4 described below), we indicate native components of the service provider that require installation on the device 102. These native components are developed using non-HTML 5 tools, for example using C++.

The dynamic content on the server 116 (that is, at domain y.com) is downloaded onto the web application instance 204_{y} on the browser 202_{y} and when that dynamic content is executed on the device 102 it causes the web application instance 204_{y} to download JavaScript and CSS files from the server 114 (at domain x.com) associated with the service provider. The downloaded JavaScript code that comes from the server 114 (x.com) instructs the web application instance 204_{y} to instantiate specific UI elements of the client application within the web application instance DOM (Document Object Model). This is shown in FIG. 2 whereby the UI widget 206_{y} is instantiated in the web application instance 204_{y}. The control and state module 208_{y} of the client is also instantiated within the web application instance 204_{y} as shown in FIG. 2.

Similarly, the dynamic content on the server 118 (that is, at domain z corn) is downloaded onto the web application instance 204_{z} on the browser 202, and when that dynamic content is executed on the device 102 it causes the web application instance 204, to download JavaScript and CSS files from the server 114 (at domain x.com) associated with the service provider. The downloaded JavaScript code that comes from the server 114 (x.com) instructs the web application instance 204, to instantiate specific UI elements of the client application within the web application instance DOM (Document Object Model). This is shown in FIG. 2 whereby the UI widget 206, is instantiated in the web application instance 204_{y}. The control and state module 208, of the client is also instantiated within the web application instance 204, as shown in FIG. 2.

It can be appreciated from FIG. 2 that the web-based parts of the client application which are downloaded from the server 114 (at domain x.com) are layered and the UI module 206 is split from the control and state module 208.

The native capabilities of the service provider client application are made accessible to the web content on the web application instances 204_{y} and 204_{z} by hosting them in a respective browser plugin 210_{y} and 210_{z}, provided by the service provider. As described above the browser plugins 210_{y} and 210_{z} are installed on the device 102 and use a technology that is native to the device platform of the device 102.

In the arrangement shown in FIG. 2, the client application is implemented on the browser 202_{y} separately to the implementation of the client application on the browser 202_{z}. This means that there is no ability to coordinate between the integration of the service provider client application with the browsers 202_{y} and 202_{z} from the multiple partners. Each partner integration forms a separate silo on the user device 102, such that no device-wide control of the client application can be provided.

Furthermore, the arrangement shown in FIG. 2 is only suitable if there is no constraint against multiple instantiations of the native parts of the service provider client application. As described above, there can be many reasons for implementing such a constraint, for example when the client application relates to Internet communication services.

It can therefore be appreciated that there are problems with the arrangement shown in FIG. 2.

FIG. 3 represents an integration of two web application instances 304_{y} and 304_{z} with a client application in a second prior art arrangement. In this second prior art arrangement the native parts of the client application are hosted by a central program referred to herein as a central application daemon 316. The applications referred to herein are executed on the CPU 106 of the device 102 in accordance with known techniques for executing applications. If the applications are to store data then the data may be stored in the memory 108 of the device 102.

The web browser 302_{y} is associated with the server Y 116 operated by a partner Y. The web browser 302_{y} includes a web application instance 304_{y} which is implemented on the device 102. The web browser 302_{y} also includes a RPC plugin 314_{y} which provides thin Remote Procedure Call (RPC) functionality in the browser plugin 314_{y}. Similarly, the web browser 302, is associated with the server Z 116 operated by a partner Z. The web browser 302_{z} includes a web application instance 304_{z} which is implemented on the device 102. The web browser 302_{y} also includes a RPC plugin 314_{y} which provides thin Remote Procedure Call (RPC) functionality in the browser plugin 314_{y}. The device implements a central application daemon 316 on which is implemented the native parts of the client application of the service provider and the control and state module 308. The central application daemon 316 can communicate with the RPC plugins 314_{y} and 314_{z} over a Transmission Control Protocol (TCP) connection using the RPC functionality of the plugins 314_{y} and 314_{z}. The central application daemon 316 can be installed by the service provider on the device 102 and uses a native technology of the device platform of the device 102 (e.g. C++). The central application daemon 316 provides for device-wide control of the client application using the control and state module 308. As described above in relation to FIG. 2, the web application instances 304_{y} and 304_{z} originated at web servers 116 and 118 at domains y.com and z.com and are downloaded to the device 102 via the network 112. Each of these web application instances 304_{y} and 304_{z} runs in a separate instance of a web browser (302_{y} and 302_{z}). By the instance of the web browser it is meant herein a window, tab, or frame, including concurrent use of various browser vendors (e.g. Browser1: Microsoft Internet Explorer, Browser2: Google Chrome). Each web application instance 304_{y} and 304_{z} constructs suitable UI widgets (306_{y} and 306_{z} respectively) of the service provider. The UI widgets 306 are UI modules of the client application of the service provider. The UI widgets 306 originated at the web server 114 of the service provider at domain x.com.

In the arrangement shown in FIG. 3, the concurrent partner web application instances 304_{y} and 304_{z} load and instantiate the UI web widgets 306_{y} and 306_{z} from the server 114 of the service provider (at domain x.com). However, in contrast to the arrangement in FIG. 2, the native libraries of the client application are this time hosted centrally on the device 102 in a separate process of the central application daemon 316. Communication between the browsers (302_{y}, 302_{z}) and the central application daemon 316 is provided using TCP sockets (or other local Inter Process Communication (IPC) tools such as named pipes).

As can be appreciated from viewing FIG. 3, the arrangement shown in FIG. 3 conforms to the constraint against multiple instantiations of the native parts of the service provider client application. Only one instance of the native parts (e.g. the native libraries 312) of the client application is implemented at the device 102 at any given time—that being on the central application daemon 316.

The component of the client application that coordinates the behaviour of the client application across the whole device 102 is shown as the “controller and state” module 308. This controller and state module 308 has a central location on the device 102, because it resides in the central application daemon 316. However, due to this central location, it has also a native characteristic, e.g. it is developed in non-HTML 5 environment, e.g. using C++. Therefore, as described above, upgrade of the controller and state components of the client application does not leverage the upgrade-ability of the web-based technologies such as those conforming to the HTML 5 standard.

It can therefore be appreciated that there are problems with the arrangement shown in FIG. 3.

Preferred embodiments of the invention are described herein by way of example only. FIG. 4 represents an integration of web application instances (404_{y}, 404_{z}) and a client application of the service provider in accordance with a preferred embodiment. The arrangement shown in FIG. 4 overcomes problems associated with the arrangements shown in FIGS. 2 and 3.

FIG. 4 represents an integration of two web application instances 404_{y} and 404_{z} with a client application in a preferred embodiment. The native parts of the client application are hosted by a central program referred to herein as a central application daemon 416. Indeed the native parts of the client application are hosted on a native section 418 of the central application daemon 416. The central application daemon 416 also has a JavaScript engine 424 on which is implemented a control and state module 408 of the client application which is implemented using a web-based technology such as one which conforms to the HTML 5 standard. Also implemented on the JavaScript engine 424 is a RPC plugin 422 which allows communication (e.g. using a TCP connection) between the native section 418 of the central application daemon 416 and the JavaScript engine 424 of the central application daemon 416. The applications referred to herein are executed on the CPU 106 of the device 102 in accordance with known techniques for executing applications. If the applications are to store data then the data may be stored in the memory 108 of the device 102.

The web browser 402_{y} is associated with the server Y 116 operated by a partner Y. The web browser 402_{y} includes a web application instance 404_{y} which is implemented on the device 102. The web browser 402_{y} also includes a RPC plugin 414_{y} which provides thin Remote Procedure Call (RPC) functionality in the browser plugin 414_{y}. Similarly, the web browser 402, is associated with the server Z 116 operated by a partner Z. The web browser 402, includes a web application instance 404, which is implemented on the device 102. The web browser 402_{y} also includes a RPC plugin 414_{y} which provides thin Remote Procedure Call (RPC) functionality in the browser plugin 414_{y}. The native section 418 of the central application daemon 416 can communicate with the RPC plugins 414_{y} and 414_{z} over a Transmission Control Protocol (TCP) connection using the RPC functionality of the plugins 414_{y} and 414_{z}. The central application daemon 416 can be installed by the service provider on the device 102 and the native section 418 uses a native technology of the service provider (e.g. C++). The central application daemon 416 provides for device-wide control of the client application using the control and state module 408.

The web application instances 404_{y} and 404_{z} originated at web servers 116 and 118 at domains y.com and z.com and are downloaded to the device 102 via the network 112. Each of these web application instances 404_{y} and 404_{z} runs in a separate instance of a web browser (402_{y} and 402_{z}). By the instance of the web browser it is meant herein a window, tab, or frame, including concurrent use of various browser vendors (e.g. Browser1: Microsoft Internet Explorer, Browser2: Google Chrome). Each web application instance 404_{y} and 404_{z} constructs suitable UI widgets (406_{y} and 406_{z} respectively) of the service provider. The UI widgets 406 are UI modules of the client application of the service provider. The UI widgets 406 originated at the web server 114 of the service provider at domain x.com.

In the arrangement shown in FIG. 4, the concurrent partner web application instances 404_{y} and 404_{z} load and instantiate the UI web widgets 406_{y} and 406_{z} from the server 114 of the service provider (at domain x.com). The native libraries of the client application are hosted centrally on the device 102 in the native section 418 of the central application daemon 416. Communication between the browsers (402_{y}, 402_{z}) and the native section 418 of the central application daemon 416 is provided using TCP sockets (or other local Inter Process Communication (IPC) tools such as named pipes).

As can be appreciated from viewing FIG. 4, the arrangement shown in FIG. 4 conforms to the constraint against multiple instantiations of the native parts of the service provider client application. Only one instance of the native parts (e.g. the native libraries 412) of the client application is implemented at the device 102 at any given time—that being on the native section 418 of the central application daemon 416.

The component of the client application that coordinates the behaviour of the client application across the whole device 102 is the control and state module 408. This control and state module 408 has a central location on the device 102, because it resides in the central application daemon 416. Advantageously, the control and state module 408 is implemented on the JavaScript engine 424 of the central application daemon 416. In this way the control and state module 408 is able to use web-based technology such as technology conforming to the HTML 5 standard. Therefore, as described above, upgrade of the control and state module 408 of the client application is able to leverage the upgrade-ability of the web-based technologies.

In FIG. 4 we indicate with white colour web components implemented at the device 102 which conform to the HTML 5 standard, e.g. those components implemented with HTML, JavaScript and CSS tools. With grey colour in FIG. 4, we indicate native components that require installation on the device 102. These native components are developed using non-HTML 5 tools, for example using C++.

The arrangement shown in FIG. 4 provides the means for client side integration between web application instances 404 of the partners and the hybrid (that is, web and native) client application of the service provider. The arrangement shown in FIG. 4 also provides for a concurrent integration with multiple partners (e.g. both web application instances 404_{y} and 404_{z}).

In the example shown in FIG. 4 the web application instances (404_{y} and 404_{z}) execute concurrently in separate web browsers (402_{y} and 402_{z}). The notion of the “browser” is generalized to encompass browser window, tab or frame, including coexisting multiple installations of browsers from different vendors (e.g. Microsoft Internet Explorer and Google Chrome).

The UI widgets 406_{y} and 406_{z} are minimal in the sense that they have their responsibility reduced to handling of the graphical user interface for output on the display 110 to the user 104. All other functionality of the client application is delegated to the central application daemon 416 to be handled centrally. As described above, this delegation of functionality is mediated by special Remote Procedure Call (RPC) plugins (414_{y} and 414_{z}) of the browsers (402_{y} and 402_{z}). The plugins 414_{y} and 414_{z} are provided by the service provider, and downloaded to the browsers 402_{y} and 402_{z} from the server 114 (at domain x.com). The responsibility of the plugins 414 is reduced to merely relaying control messages in both directions between the native section 418 of the central application daemon 416 and the UI widgets 406.

As described above, the central application daemon 416 is split into two parts:
1. A native part holding three essential components:
   a. native libraries 412 of the service provider;
   b. a RPC hub 420 allowing flexible and secure signalling between multiple web components (e.g. browsers 402) distributed across the device 102; and
   c. an instance of the JavaScript engine 424.
2. A web-based part consisting of a control and state module 408 which is conformant to the HTML 5 standard, and downloaded to the device 102 dynamically from the service provider web server 114 (at domain x.com).

The JavaScript engine 424 embedded in the central application daemon 416 allows the control and state module 408 of the client application to be both centrally positioned on the device 102 (on the central application daemon 416), and implemented using web-based technology, i.e. it is web oriented. Several choices of such an embeddable JavaScript engine 424 exist, including a Webkit browser and Google's V8 JavaScript engine.

As described above, the HTML 5 nature of the control and state module 408 of the preferred embodiments allows leveraging the following benefits of web-based technology:
1. Web upgradeability of the component, as it is loaded dynamically from the service provider web server 114, just like a regular web page, subject to typical performance optimizations in the form of browser caching.
2. Use of a HTML 5 database for storing of state.
3. Powerful application development tools, and mainstream web developer skills available on the market.

In order to connect the components implemented in the device 102 together in such a way that they function together in a coordinated way, the invention provides for some distributed computing facilities are provided in the device 102. These distributed computing facilities include:
1. RPC plugins (414 and 422), in all involved browsers 402 which includes: (i) web browsers 402 used to load the partner web application instances 404, i.e. the off the shelf browsers installed by the user 104 on the device 102, such as Microsoft Internet explorer or Google Chrome; and (ii) the embedded JavaScript engine 424, which may for example be Webkit.
2. TCP connections between RPC plugins (414 and 422) and the native section 418 of the central application daemon 416.
3. A RPC hub 420 hosted by the central application daemon 416. This RPC hub 420 uses the TCP connections between the RPC plugins (414 and 422) and the daemon 416, and implements a higher level publish—subscribe communication facility, allowing the JavaScript code across the device 102 to communicate with each other.

In a publish-subscribe communication process senders of messages (referred to as “publishers”) do not program the messages to be sent directly to specific receivers (referred to as “subscribers”). Instead, published messages are characterized into classes without knowledge of what, if any, subscribers there may be. Subscribers express interest in one or more classes, and then only receive messages that are of interest (i.e. of the specified class(es)) without knowledge of what, if any, publishers there are.

The components in the device 102 exchange control messages between the RPC plugins (414 and 422) and the native section 418 of the client application over TCP connections using a structured data format, such as JavaScript Object Notation (JSON).

The distributed computing facilities in the device 102 allow two kinds of communication to occur:
1. The centralized web based controller (i.e. the control and state module 408) can access the capabilities of the native libraries 412; and
2. Numerous web based UI widgets (406) can communicate bi-directionally with the centralized web based controller (i.e. the control and state module 408) using publish-subscribe capabilities of the RPC hub 420.

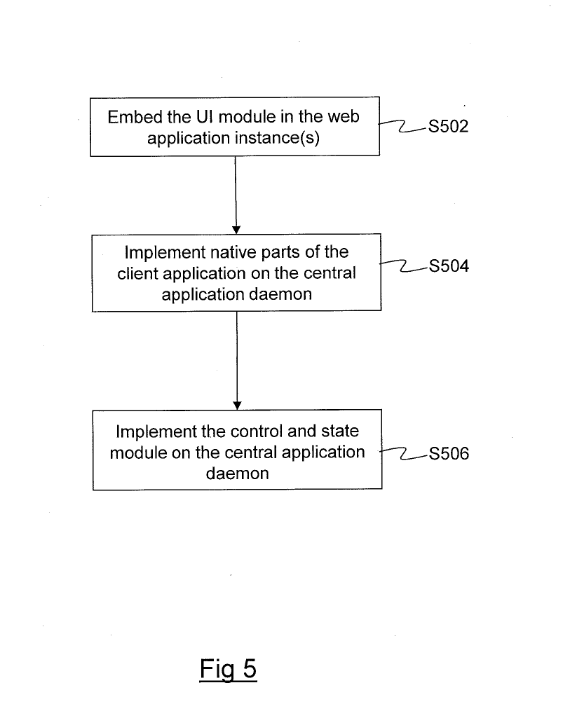

FIG. 5 shows a flow chart representing a process of integrating a client application with the web application instances 404 on the device platform of the device 102 in accordance with the arrangement shown in FIG. 4 and described above. In step S502 the UI module(s) 406 are downloaded from the server 114 and embedded in the web application instance(s) 404. The UI modules 406 are implemented using a web-based technology.

In step S504 native parts of the client application are implemented on the central application daemon 416. The native parts of the client application are installed on the device 102 (e.g. stored in memory 108) and implemented using a technology that is native to the device platform.

In step S506 the control and state module 408 is implemented on the central application daemon 416. The control and state module 408 is implemented using a web-based technology on the JavaScript engine 424 of the central application daemon 416.

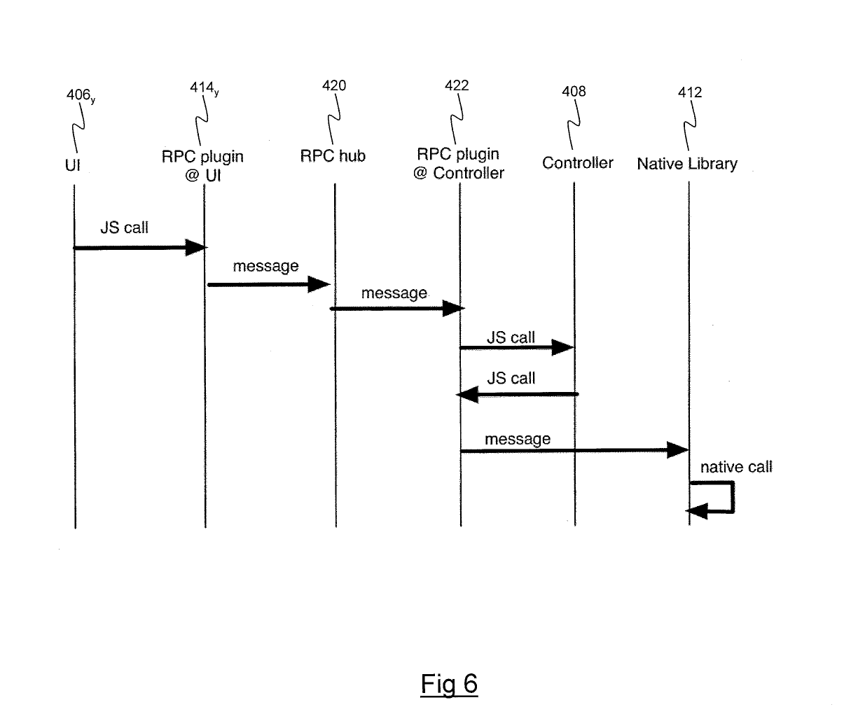

The nature of the operation of the invention is made clearer using two general examples. FIG. 6 shows a message sequence diagram showing the communication of messages between components in the device 102 in the first example. The first example, as shown in FIG. 6, illustrates a general case of an interaction that is initiated by the user 104 using the UI widget 406_{y}. The interaction involves the web-based controller 408 and the native libraries of the client application 412.

The following steps are implemented in the first example in accordance with the diagram of FIG. 6:

1. In response to some user action, the UI widget 406_{y} invokes a JavaScript call on the RPC plugin 414_{y} residing in the browser 402_{y} where the UI widget 406_{y} is loaded.
2. The effect of this call is the transmission of the complementary JSON message over the TCP connection from the RPC plugin 414_{y} to the RPC hub 420 located in the native section 418 of the central application daemon 416.
3. The RPC hub 420 relays the message to the controller 408 (i.e. the control and state module 408), instructed so by the channel subscribed to by the controller 408 (according to the publish-subscribe protocol), and which was selected by the UI widget 406_{y}.
4. The JSON message directed to the controller 408 is received by the RPC plugin 422 residing in the JavaScript engine 424 of the central application daemon 416 and then passed to the controller 408.
5. The controller invokes a JavaScript call on its own RPC plugin 422, effecting a transmission of the complementary JSON message towards the native library 412 component of the central application daemon 416. This is equivalent to remotely invoking the services of this native library 416.
6. The native library implements the request contained in the JSON message from the controller 408, by executing its own native code (i.e. implemented using the native technology).

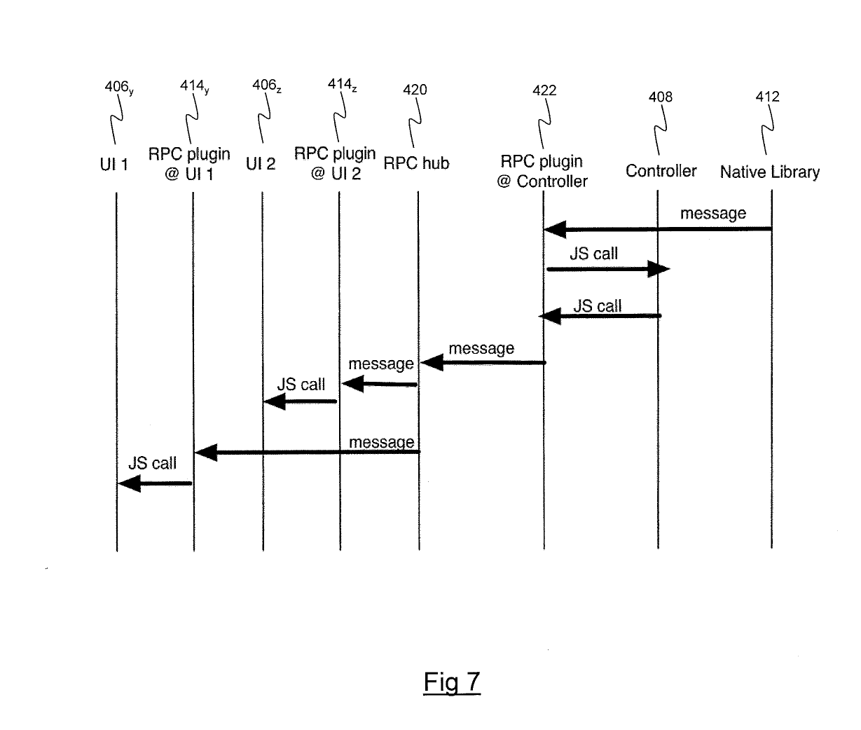

FIG. 7 shows a message sequence diagram showing the communication of messages between components in the device 102 in the second example. The second example illustrates a general case of an interaction that is initiated by the native library 412. The nature of the event that triggers the interaction within the native library 412 does not affect the messaging sequence of the second example. As an example the event may be a receipt of a network message from another element of the system 100, whether a server or a peer located somewhere on the network 112.

The following steps are implemented in the second example in accordance with the diagram of FIG. 7:

1. An event occurs within the native library 412.
2. The native library 412 transmits a complementary JSON message to the controller 408 (i.e. the control and state module 408) via co-located RPC plugin 422 in the central application daemon 416, i.e. embedded into the JavaScript engine 424 that runs the controller 408.
3. The RPC plugin 422 of the controller 408 delivers the event message to the controller 408 via a JavaScript call.
4. The controller 408 runs appropriate business logic, coded in JavaScript, based on the state held in the HTML 5 database of the JavaScript engine 424, and on the contents of the event. The controller 408 makes certain decisions and state transitions that need to be communicated to the UI widgets 406_{y} and 406_{z}.
5. The controller 408 transmits a JSON message (via the RPC plugin 422) directed at the RPC hub 420, including the publish-subscribe channel that logically selects the entity of the notification.
6. The RPC hub 420 relays the message on TCP connections linking it with the RPC plugins 414_{y} and 414₂ of the UI widgets 406_{y} and 406_{z} that expressed an interest in the notification by subscribing on the complementary publish-subscribe channel. The example shown in FIG. 7 shows two such UI widgets 406_{y} and 406_{z} receiving the notification. There can be other UI widgets executing concurrently with 406_{y} and 406_{z}, but which do not subscribe for this particular notification.
7. The RPC hub 420 sends the message on both TCP sockets linking it with the RPC plugins 414_{y} and 414_{z} collocated with UI modules 406_{y} and 406_{z}.
8. Each RPC plugin 414_{y} and 414_{z} in turn makes a complementary JavaScript call on the UI widget 406_{y} and 406_{z}, delivering the content of the message.
9. Each UI widget 406_{y} and 406_{z} delivers appropriate graphical presentation of the event for the user 104, e.g. on the display 110 of the device 102.

The arrangements described herein in relation to FIG. 4 combine different advantages of the prior art arrangements shown in FIGS. 2 and 3 discussed above while eliminating at least some of their shortcomings.

In particular, the arrangement shown in FIG. 4 inherits the web-based nature of the control and state module exhibited in the first prior art arrangement shown in FIG. 2. However, the arrangement of FIG. 4 does not suffer from the shortcoming of the arrangement of FIG. 2 where each partner's application integration forms a separate silo on the user's device 102. Instead, in the arrangement shown in FIG. 4 the web-based control and state module 408 has a central position on the device. This is facilitated by having a JavaScript engine implemented on the central application daemon 406 thereby allowing web-based modules (such as the control and state module 408) to be implemented centrally on the central application daemon 406. This is achieved whilst still allowing the native parts of the client application to be implemented centrally on the device 102 using the native section 418 of the central application daemon 416.

Comparing to the second prior art arrangement shown in FIG. 3, the arrangement shown in FIG. 4 inherits the central position of the control and state module on the user's device, but avoids native implementation constraints for this module. Instead the invention provides a capability to make the controller and state module both central on the device AND web oriented, i.e. developed using HTML 5 tools and downloaded from a web server (server 114 at domain x.com).

In addition, the invention provides some non-functional advantages in the area of resiliency.

The first prior art arrangement shown in FIG. 2 executes the native parts of the client application in the plugin 210 that is within a process of the browser 202 running the partner web application 204. A crash of the native parts of the service provider client application takes down the browser 202 with it. In this case, the problems of the service provider implementation are exhibited in the partner web application instance 204 thereby causing a bad user impression of the partner web application instance 204 because of the problems in the service provider implementation. In contrast, the arrangement shown in FIG. 4 does not suffer from this problem as only a very thin Remote Procedure Call (RPC) functionality of the client application is left in the browser plugin 414, with most of the native code moved to a separate process in the central application daemon 416. Therefore if the native code of the client application crashes it does not cause the browser 402 to crash, thereby creating a better user impression of the web application instance 404 than when the native code of the client application crashes in the arrangement shown in FIG. 2.

The second prior art arrangement shown in FIG. 3 combines all the non-UI code of the service provider client application in one place in the central application daemon 316. A crash in any of the (non-UI) components of the client application takes the whole daemon process 316 down. In contrast in the arrangement shown in FIG. 4 the code of the control and state module 408 is separated from the native libraries 412 in the central application daemon 416, thereby limiting the crash impact of each single component. In other words, if one part of the client application (e.g. the control and state module 408) crashes it does not cause the other, separated parts of the client application (e.g. the native libraries 412) to also crash, and vice versa.

There is therefore described an arrangement for integrating a client application with web application instances on the device 102 which provides centralised control and state module 416 that can also be implemented using web-based technologies. This is achieved by implementing the JavaScript engine 424 on the central application daemon thereby allowing the control and state module 408 to be both centralised and web-based.

The components (402 to 424) shown in FIG. 4 are preferably implemented in software for execution by the CPU 106 on the device 102. For example, the components may be provided by way of a computer program product embodied on a non-transient computer-readable medium which is configured so as when executed on the CPU 106 of the device 102 to perform the methods described herein. Alternatively, the components (402 to 424) shown in FIG. 4 may be implemented in hardware modules on the device 102.

The device 102 may be of any suitable type on which the applications described herein can be implemented. For example, the device 102 may be a mobile phone, a personal computer, a laptop, a television or any other device which can store and execute the applications described herein and can also connect to, and communicate with, the network 112.

The service provider client application may be a client application for communicating over the network 112, e.g. with other user devices connected to the network 112. The client application may be for performing other functions at the device 102 as would be apparent to a person skilled in the art.

Furthermore, while this invention has been particularly shown and described with reference to preferred embodiments, it will be understood to those skilled in the art that various changes in form and detail may be made without departing from the scope of the invention as defined by the appendant claims.

What is claimed is:

1. A method of integrating a client application, associated with a service provider, with at least one web application instance implemented on a device platform of a device, the method comprising:
embedding a respective at least one user interface module of the client application into the at least one web application instance, said at least one user interface module being implemented using web-based technology;
implementing native parts of the client application in a centralized manner on the device, said native parts of the client application being installed on the device and being implemented using technology that is native to the device platform; and
implementing a control module of the client application in a centralized manner on the device, said control module being implemented using web-based technology.

2. The method of claim 1 wherein there is only one instance of the native parts of the client application implemented on the device at a time.

3. The method of claim 1 wherein there is only one instance of the control module of the client application implemented on the device at a time.

4. The method of claim 1 wherein the native parts of the client application and the control module of the client application are implemented using a centralized program on the device.

5. The method of claim 1 wherein the native parts of the client application include at least one of: (i) native libraries of the service provider, (ii) a Remote Procedure Call hub for facilitating signalling between components on the device which use web-based technology, and (iii) an instance of a JavaScript engine.

6. The method of claim 1 wherein the control module is downloaded to the device from the service provider via the Internet.

7. The method of claim 1 further comprising upgrading the control module via web-based communication.

8. The method of claim 1 wherein the control module facilitates access between the at least one user interface module and the native parts of the client application.

9. The method of claim 1 wherein a respective browser plugin is implemented for each web application instance, said browser plugin having Remote Procedure Call functionality for communicating with at least one of the control module and the native parts of the client application.

10. The method of claim 9 wherein the Remote Procedure Call functionality facilitates Transmission Control Protocol connections for relaying control messages between the at least one web application instance and said at least one of the control module and the native parts of the client application.

11. The method of claim 10 wherein the control messages are relayed using publish-subscribe communication.

12. The method of claim 1 wherein there are a plurality of web application instances implemented on the device, wherein each web application instance is controlled by the control module of the client application.

13. The method of claim 1 wherein the control module is a control and state module of the client application.

14. The method of claim 1 wherein the web based technology conforms to the HTML 5 standard.

15. A computer program product for integrating a client application, associated with a service provider, with at least one web application instance implemented on a device platform of a device, the computer program product being embodied on a non-transient computer-readable medium and configured so as when executed on a processor of the device to perform the operations of:
embedding a respective at least one user interface module of the client application into the at least one web application instance, said at least one user interface module being implemented using web-based technology;
implementing native parts of the client application in a centralized manner on the device, said native parts of the client application being installed on the device and being implemented using technology that is native to the device platform; and
implementing a control module of the client application in a centralized manner on the device, said control module being implemented using web-based technology.

16. A device configured to integrate a client application, associated with a service provider, with at least one web application instance implemented on a device platform of the device, the device being configured to:
embed a respective at least one user interface module of the client application into the at least one web application instance, said at least one user interface module being implemented using web-based technology;
implement native parts of the client application in a centralized manner on the device, said native parts of the client application being installed on the device and being implemented using technology that is native to the device platform; and
implement a control module of the client application in a centralized manner on the device, said control module being implemented using web-based technology.

17. The device of claim 16 wherein the native parts of the client application and the control module of the client application are implemented using a centralized program on the device.
